(19) United States
(12) Patent Application Publication
(10) Pub. No.: US 2025/0139555 A1
(43) Pub. Date: May 1, 2025

(54) APPARATUS AND METHOD FOR FINANCIAL FORECASTING AND VERSION LOG CREATION

(71) Applicant: RAKUTEN SYMPHONY, INC., Setagaya-ku, Tokyo (JP)

(72) Inventors: Anindita DATTA, Tokyo (JP); Asfak KHAN, Indore (IN); Aman SHEIKH, Indore (IN)

(73) Assignee: RAKUTEN SYMPHONY, INC., Setagaya-ku, Tokyo (JP)

(21) Appl. No.: 18/013,833

(22) PCT Filed: Oct. 31, 2022
(86) PCT No.: PCT/US2022/048353

§ 371 Date: Dec. 29, 2022

(51) Int. Cl. G06Q 10/0637; G06F 16/21

(52) U.S. Cl. CPC G06Q 10/0637; G06F 16/219

(57) ABSTRACT

An apparatus for financial forecasting, wherein the apparatus controls a user interface to be displayed on a display and controls receiving a plurality of financial forecasting data submissions that are submitted using the user interface. The apparatus also controls storing each one of the plurality of financial forecasting data submissions as a different version in a version log. The apparatus also controls receiving and storing at least one of an approval and a rejection, using the user interface, for each one of the stored plurality of financial forecasting data submissions and controls the user interface to display the version log in response to a request input using the user interface.

### FIELD

Apparatuses and methods consistent with example embodiments of the present disclosure relate to configuring financial forecasting and version log creation. In particular, apparatuses and methods consistent with example embodiments of the present disclosure relate to a complete financial forecasting module for financial data management and version log creation for submitted financial forecasting data.

### BACKGROUND

Financial forecasting is an important tool used by organizations to predict the organization's financial future and to facilitate decision-making relevant for determining future financial performance. Financial forecasting is an activity that is typically undertaken in the current financial year in a periodic manner (e.g., each week, month, quarter, etc.) to track the actual expenses incurred by the organization and to check if there is any deviation from the planned approved budget.

For instance, a department budget for each department of the organization may be prepared annually. Once the annual department budget is prepared and approved, the organization may thereafter check whether the actual expenditures match the approved budget and/or generate financial forecasting data which forecasts whether the organization will adhere to, or may deviate from, the approved budget.

In other words, when using pre-scheduled/approved/planned budgets, a person in charge must check the financial forecasting data submitted and ensure that the financial forecasting is synced with the pre-scheduled/approved/planned budget to ensure the proper usage of financial resources and that the organization is not deviating from the budget approved. The person in charge may then approve or reject the submitted financial forecasting data.

In the related art, some organizations use a financial forecasting software module to help the organization prepare and analyze their budgets and to help the organization adapt to any changing plans, circumstances, etc., and forecast expenses accurately. However, in the related art, financial forecasting is a largely manual process using spreadsheets, etc., which is time consuming, inconvenient and prone to human error. Moreover, related art tools do not provide organizations the ability to leverage proper finances and management due to lack of real time management of financial data and proper forecasting. For instance, related art tools do not automate entry of financial forecasting data for each submission period based on past history. Related art tools also do not efficiently store each financial forecasting data submission as a different version that can be subsequently referenced using a version log.

Hence, there is a need for a proper financial forecasting module adapted for end-to-end financial management which stores every submission of financial forecasting data as a different version in a version log for a user to easily reference, as needed, to prepare and manage financial forecasting data.

### SUMMARY

According to embodiments, apparatuses and methods are provided for financial forecasting and version log creation. A non-limiting embodiment stores each financial forecasting data submission as a different version in a version log that can be subsequently referenced. This, an example embodiment may, therefore, (among other advantages) improve the efficiency, accuracy and ease of financial forecasting.

An example embodiment provides an apparatus for financial forecasting, the apparatus including: a memory storing instructions; and a processor configured to execute the stored instructions to implement operations including: controlling a user interface to be displayed on a display; controlling receiving a plurality of financial forecasting data submissions that are submitted using the user interface; controlling storing each one of the plurality of financial forecasting data submissions as a different version in a version log; controlling receiving and storing at least one of an approval and a rejection, using the user interface, for each one of the stored plurality of financial forecasting data submissions; and controlling the user interface to display the version log in response to a request input using the user interface.

An example embodiment may provide the apparatus, wherein the operations further include controlling receiving and storing, using the user interface, approver comments for each different version stored in the version log.

An example embodiment may provide the apparatus, wherein the operations further include controlling receiving and storing, using the user interface, a file attached to each different version stored in the version log.

An example embodiment may provide the apparatus, wherein the operations further include controlling the user interface to automatically populate a field of the financial forecasting data using a past history of financial forecasting data submissions.

An example embodiment may provide the apparatus, wherein the operations further include controlling the user interface to automatically populate the field of the financial forecasting data using a previous amount from a most recent one of the financial forecasting data submissions.

An example embodiment provides a method for financial forecasting, the method including: controlling, by a processor, a user interface to be displayed on a display; controlling, by the processor, receiving a plurality of financial forecasting data submissions that are submitted using the user interface; controlling, by the processor, storing each one of the plurality of financial forecasting data submissions as a different version in a version log; controlling, by the processor, receiving and storing at least one of an approval and a rejection, using the user interface, for each one of the stored plurality of financial forecasting data submissions; and controlling, by the processor, the user interface to display the version log in response to a request input using the user interface.

An example embodiment may provide the method, wherein the method further includes controlling, by the processor, receiving and storing, using the user interface, approver comments for each different version stored in the version log.

An example embodiment may provide the method, wherein the method further includes controlling, by the processor, receiving and storing, using the user interface, a file attached to each different version stored in the version log.

An example embodiment may provide the method, wherein the method further includes controlling, by the processor, the user interface to automatically populate a field of the financial forecasting data using a past history of financial forecasting data submissions.

An example embodiment may provide the method, wherein the method further includes controlling, by the processor, the user interface to automatically populate the field of the financial forecasting data using a previous amount from a most recent one of the financial forecasting data submissions.

An example embodiment may provide a non-transitory computer readable storage medium storing instructions which, if executed, cause a processor to implement operations for financial forecasting, the operations including: controlling, by a processor, a user interface to be displayed on a display; controlling, by the processor, receiving a plurality of financial forecasting data submissions that are submitted using the user interface; controlling, by the processor, storing each one of the plurality of financial forecasting data submissions as a different version in a version log; controlling, by the processor, receiving and storing at least one of an approval and a rejection, using the user interface, for each one of the stored plurality of financial forecasting data submissions; and controlling, by the processor, the user interface to display the version log in response to a request input using the user interface.

An example embodiment may provide the non-transitory computer readable storage medium, wherein the operations further include controlling, by the processor, receiving and storing, using the user interface, approver comments for each different version stored in the version log.

An example embodiment may provide the non-transitory computer readable storage medium, wherein the operations further include controlling, by the processor, receiving and storing, using the user interface, a file attached to each different version stored in the version log.

An example embodiment may provide the non-transitory computer readable storage medium, wherein the operations further include controlling, by the processor, the user interface to automatically populate a field of the financial forecasting data using a past history of financial forecasting data submissions.

An example embodiment may provide the non-transitory computer readable storage medium, wherein the operations further include controlling, by the processor, the user interface to automatically populate the field of the financial forecasting data using a previous amount from a most recent one of the financial forecasting data submissions.

Additional aspects will be set forth in part in the description that follows and, in part, will be apparent from the description, or may be realized by practice of the presented example embodiments of the disclosure.

### BRIEF DESCRIPTION OF THE DRAWINGS

Features, aspects and advantages of certain example embodiments of the disclosure will be described below with reference to the accompanying drawings, in which like reference numerals denote like elements, and wherein:

FIG. 1 is a diagram of an example environment in which systems and/or methods, described herein, may be implemented;

FIG. 2 is a diagram of example components of a device according to an example embodiment;

FIG. 3 shows an “Edit Forecast” window of a user interface according to an example embodiment;

FIG. 4 shows an “Upload Documents” window of a user interface according to an example embodiment;

FIG. 5 shows an “Edit Forecast” window of a user interface according to an example embodiment;

FIG. 6 shows a “Documents” window of an “Edit Forecast” window of a user interface according to an example embodiment;

FIG. 7 shows an “Edit Forecast” window of a user interface according to an example embodiment;

FIG. 8 shows a confirmation window of an “Edit Forecast” window of a user interface according to an example embodiment;

FIG. 9 shows a confirmation window of an “Edit Forecast” window of a user interface according to an example embodiment;

FIG. 10 shows an “Operation Department” window of a user interface according to an example embodiment;

FIG. 11 shows a confirmation window of an “Operation Department” window of a user interface according to an example embodiment;

FIG. 12 shows a workflow window of a user interface according to an example embodiment;

FIG. 13 shows an “Operation Department” window of a user interface in which the “View Version Log” button is highlighted according to an example embodiment;

FIG. 14 shows a version log window of a user interface according to an example embodiment;

FIG. 15 shows a version log window of a user interface according to an example embodiment, wherein the version log window also includes an “Attachments” column;

FIG. 16 shows a window of a user interface listing attachments to a particular version stored in the version log according to an example embodiment; and

FIG. 17 shows an “Operation Department” window of a user interface in which the “Approver Comments” tab has been selected according to an example embodiment.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

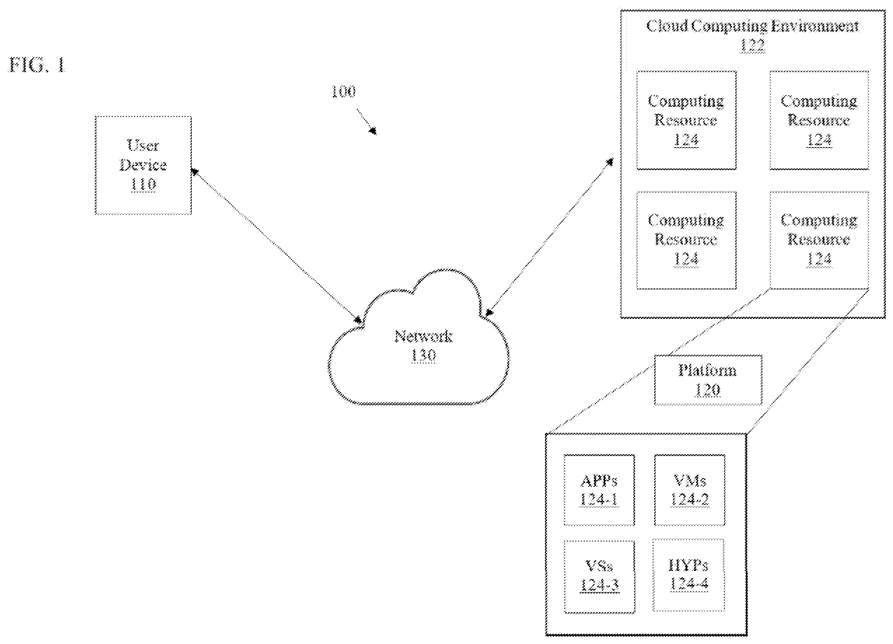

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 is an apparatus which includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating, storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

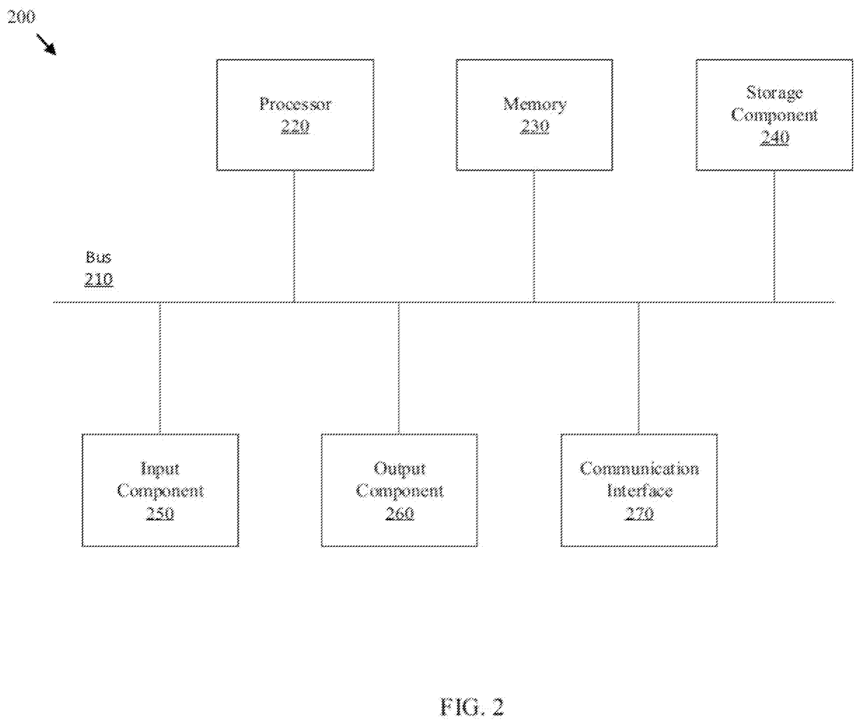

FIG. 2 is a diagram of example components of a device 200. Device 200 is an apparatus and may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

Example embodiments of the present disclosure provide an apparatus and method which provide a complete financial forecasting module for financial data management and version log creation for each submission of financial forecasting data.

For instance, after a budget (e.g., an annual budget) is approved, each department of an organization may recheck and update a financial forecasting module with updated data regarding actual expenditures, compare the actual expenditures to the approved budget, and forecast whether actual expenditures will adhere to, or may deviate from, the approved budget.

This recheck of financial forecasting data may occur periodically, at a variety of different times across the organization. For instance, one aspect of the organization in Asia may recheck financial forecasting data once per week, whereas other aspects of the organization in the United States may recheck financial forecasting data once per month. As another example, different departments within the organization may recheck financial forecasting data using any variety of different time periods. Additionally, employees across the organization may submit their financial data at different times, and different frequencies, with different work schedules and holiday calendars, and different submission periods. Further, one region or entity may follow one submission period and freeze month for all departments.

Such rechecks of the financial forecasting data submitted may be done in a periodic manner, such as weekly, or monthly, etc. Thus, an approval process for submitted financial forecasting data may be defined and may include defining various submission periods to be used in the organization.

For instance, the defined submission periods may be periods during which financial forecasting data may be submitted and periods outside of which submission of financial forecasting data is restricted.

In addition to configuring submission periods for submitting and editing financial forecasting data, an organization may also configure freeze periods, for instance, by defining freeze times after which financial forecasting data, which was already submitted and approved before the respective freeze time, is effectively frozen and may no longer be submitted, modified and/or edited by users. An organization may configure freeze periods for a wide variety of different reasons, including, but not limited to, ensure integrity of submitted financial forecasting data.

By way of illustration, one freeze time may be defined in each one of a plurality of months (e.g., the last day of each month). Further, multiple submission periods (e.g., period which extend from Monday through Wednesday of each week) may be configured that will occur before the respective freeze time in each one of the plurality of months (e.g., the last day of each month). Thus, according to one specific configuration consistent with this illustration, in the month of January, submission periods may be defined to require users to submit financial forecasting data once each week, and this submission may occur on Mondays, Tuesdays or Wednesdays of each week. Outside of Monday through Wednesday (i.e., Thursday, Friday, Saturday and Sunday) submission of financial forecasting data is restricted.

Additionally, according to this illustration, since periodic freeze periods have been configured which end on the last day of each month, then after January 31 has elapsed, and it is now the month of February, then any financial forecasting data that has already been submitted and approved for January is frozen and cannot be modified by users. However, the present application is not limited to the aforementioned example and a wide variety of submission period and freeze period configurations may be employed.

According to an example embodiment, after the respective freeze time for the month of January elapses, most users are be prohibited from submitting and editing any financial forecasting data for the month of January, whereas some privileged users may still be allowed to submit and edit financial forecasting data for the month of January, such as managers of the Accounting Department, who are responsible for correcting errors in the financial forecasting data.

Thus, according to an example embodiment, a user may select a custom time after which data submission and/or editing for a certain period is frozen (i.e., financial forecasting data for a prior period may no longer be submitted and/or edited). According to an example embodiment, a user may define a custom “Freeze Month” by configuring a particular day of each month after which submission and editing of financial forecasting data is effectively frozen. According to an example embodiment, a user may select the same day of each month to end each monthly freeze period, or a user may select different days of each respective month to end each monthly freeze period, as desired. Moreover, freeze periods may not be limited to monthly freeze periods and, according to various example embodiments, freeze periods may be configured for any period of time.

An example embodiment may provide a user interface configured to implement the aforementioned features, and other features not explicitly mentioned above. As one example, a user interface may be implemented on user device 110, as shown in FIG. 1, or implemented on device 200, as shown in FIG. 2.

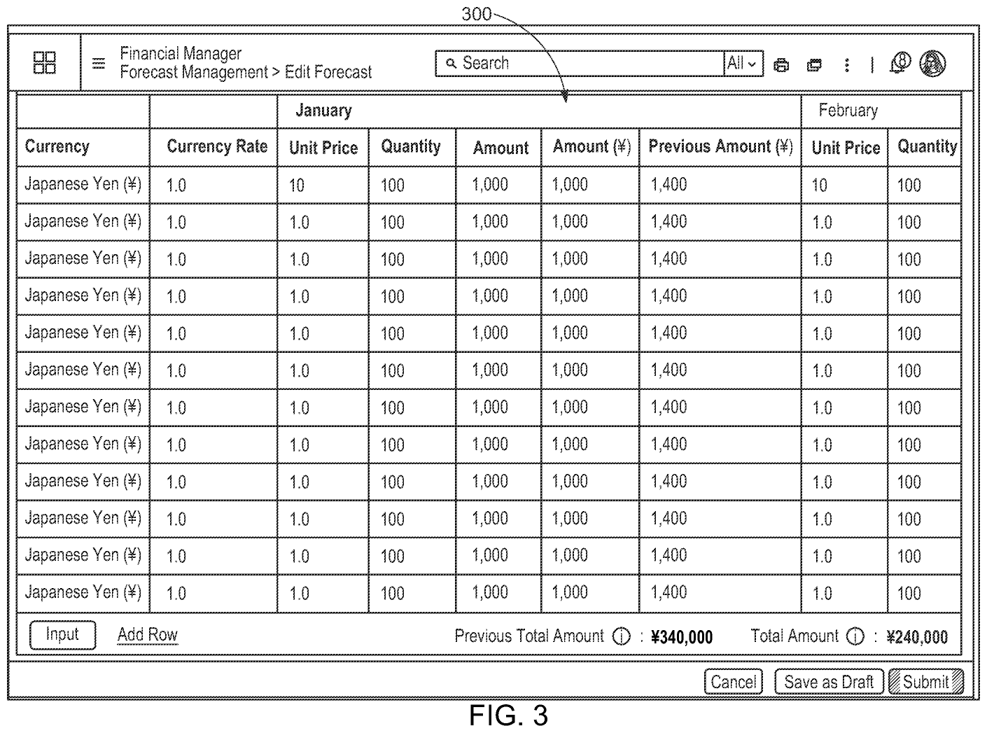

As one non-limiting example, FIG. 3 shows an “Edit Forecast” window 300 of a “Forecast Management” module of a user interface. A user may update fields, or cells, of the “Edit Forecast” window 300, for instance, by simply pointing and clicking on the desired field and editing the field using the user interface.

As shown in FIG. 3, the “Edit Forecast” window 300 displays a table comprising financial forecasting data for the months of January and February. According to one example embodiment, the approved budget is logically connected to the financial forecasting process. For instance, the financial forecasting data fields shown in FIG. 3 may initially be auto-populated based on the approved budget, which saves time and reduces manual input. Thus, a user may need only input deviations from the approved budget (if any) into the financial forecasting data fields. According to one example embodiment, the “Edit Forecast” window 300 may be configured to allow a user to update, in real-time, actual expenditures, quantities, etc., and the user interface will update financial forecasting compared to the approved budget.

In detail, as shown in FIG. 3, the “Unit Price” column of the “Edit Forecast” window 300 indicates the price per unit (e.g., a unit of hardware, however, the present application is not limited to any particular “unit”). The “Quantity” column indicates the quantity of units purchased. The “Amount” column indicates the total amount paid for the units purchased. The “Previous Amount” column indicates the total amount previously paid by the organization for respective units in a prior submission period. This “Previous Amount” column lets the user know what was the amount during the previous submission of financial forecasting data and how much is getting changed based on current financial forecasting. However, FIG. 3 is merely an example and the present application is not limited to the example shown in FIG. 3. For instance, a wide variety of financial forecasting data may be shown in the “Edit Forecast” window 300.

A user may periodically update the financial forecasting data shown in the “Edit Forecast” window 300 of FIG. 3 with the actual expenses incurred. For instance, the actual expenses may exactly match the approved budget, the actual expenses may exceed the approved budget, or the actual expenses may be less than the approved budget, and the user may update the financial forecasting data accordingly.

By way of illustration, the top line of the table shown in the “Edit Forecast” window 300 of FIG. 3 shows a forecast quantity of 100 units for the month of January. However, in actuality, the organization may only require 50 units, rather than 100 units, or the organization may require 150 units, rather than 100 units, and a user may update the “Quantity” column of the “Edit Forecast” window 300 accordingly. As a result of the user's update, the “Amount” column may be updated automatically by multiplying the “Quantity” by the “Unit Price.”

The “Amount” column may be auto-populated based on financial forecasting data that was previously submitted (e.g., a previous actual expenditure for a previous month, or a previous estimated expenditure for a previous month). Moreover, if the actual expenses match the auto-populated “Amount”, then the user may simply verify that the actual expenses match the auto-populated “Amount” and submit the financial forecasting data without any edits for that entry.

Further, submission periods may be configured during which the financial forecasting data, such as that shown in FIG. 3, may be submitted for approval. For instance, using the illustration already mentioned above, the submission periods for January may be configured as Monday through Wednesday of each week. However, the present application is not limited to this example and a wide variety of submission periods may be configured. After the financial forecasting data for the submission periods in January is submitted, and thereafter approved, then the “Previous Amount” column for February may be auto-populated based on the previous financial forecasting data submitted for January (e.g., the previous number of units, etc.).

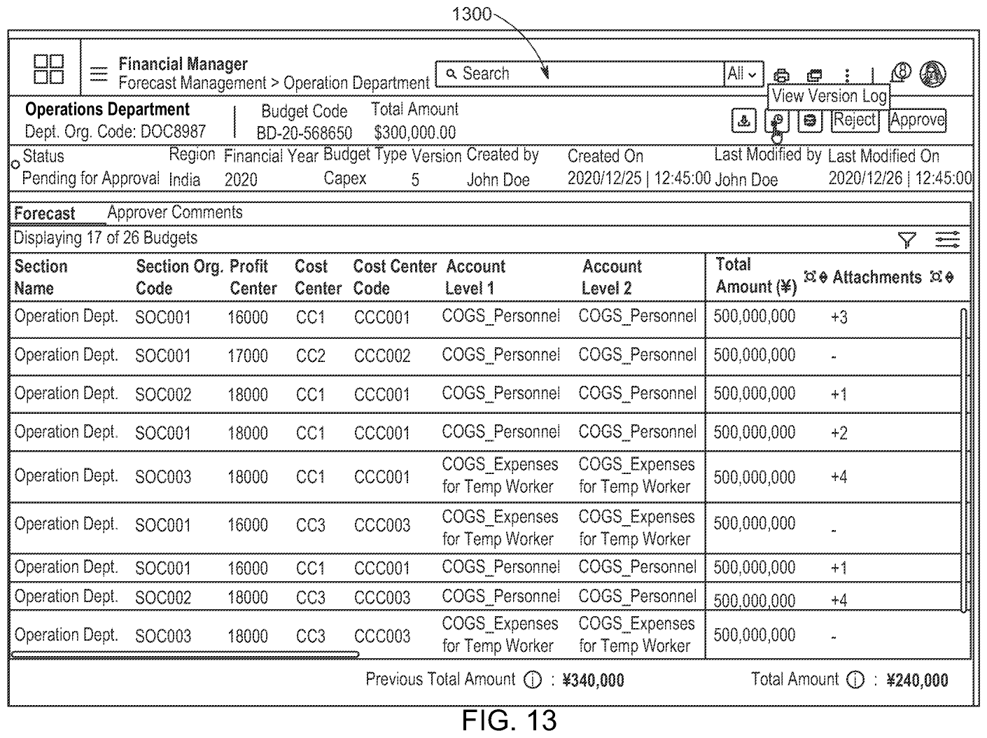

Additionally, an example embodiment creates a version log which a user may use to check financial forecasting data that was previously submitted (discussed in detail below with reference to FIGS. 13-17). For instance, once approved, each submission of financial forecasting data may be recorded and maintained as a different version in the version log. Thus, if the submission period is configured as being monthly, then each year, 12 different submissions of financial forecasting data may be recorded as different versions in the version log. Alternatively, if the submission period is configured as being weekly, then each year, 52 different submissions of financial forecasting data may be recorded as different versions in the version log.

As one non-limiting example, a user submitting financial forecasting data during February may check the version log for the number of units that were previously submitted for January, for instance, or the number of units that were previously submitted for any other previous submission period. However, the present application is not limited to the aforementioned example.

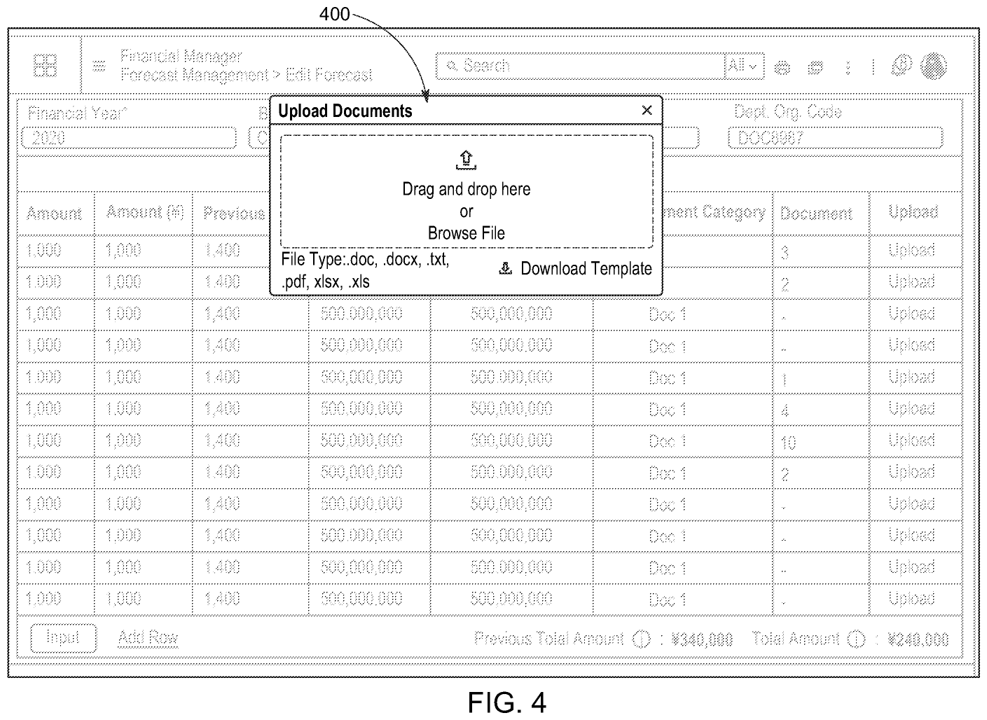

According to one example embodiment, a user may upload documents relevant to the financial forecasting data submitted (e.g., a receipt, an invoice, a proof of purchase, a purchase order, etc.). For instance, as shown in FIG. 4, an “Upload Documents” window 400 of a user interface may be displayed, which allows a user to drag and drop file(s) to upload. Thus, a user may easily reference any documents that have been uploaded to assist the user in preparing financial forecasting data for submission. Further, after the financial forecasting data is submitted for approval, the approver may easily reference any documents that have been uploaded to assist the approver in approving or rejecting the financial forecasting data submitted.

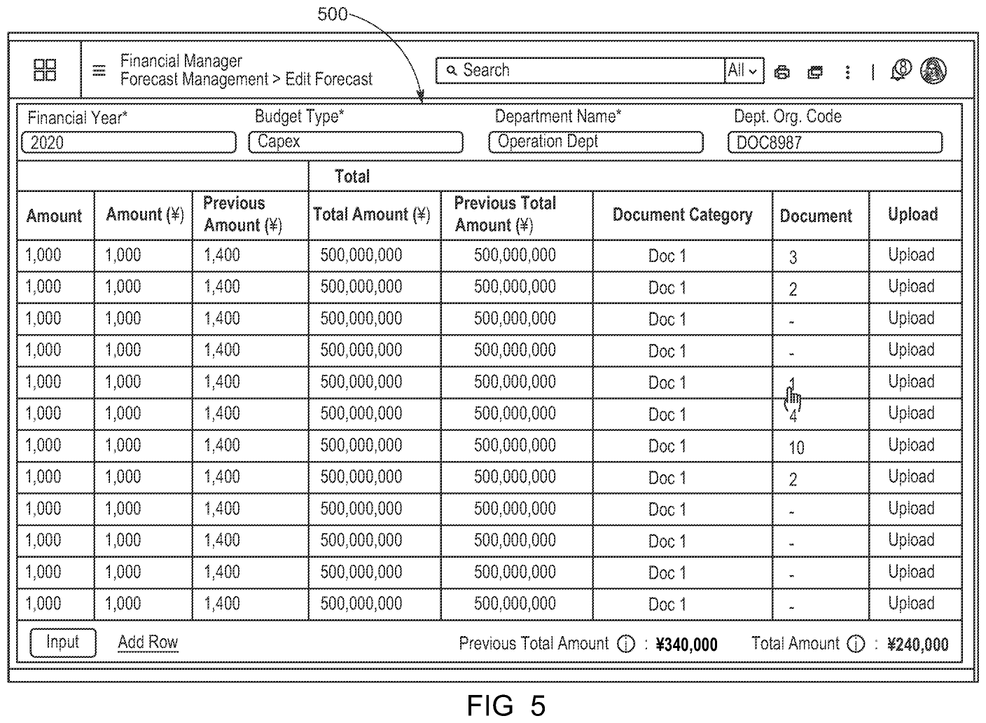

According to one example embodiment, as shown in FIG. 5, an “Edit Forecast” window 500 of a user interface may be displayed showing financial forecasting data for a respective “Financial Year” (e.g., 2020), a respective “Budget Type”, a respective “Department Name” and a respective “Dept. Org. Code” (i.e. Department Organizational Code). As shown in FIG. 5, the “Edit Forecast” window 500 may show a “Previous Total Amount” column, which may initially be automatically calculated and populated based on financial forecasting data that was previously submitted and approved. The “Edit Forecast” window 500 may also display a “Total Amount” column showing a current total amount in addition to the “Previous Total Amount” column.

Further, as shown in FIG. 5, the “Edit Forecast” window 500 may show a “Document” column indicating the number of documents that have been uploaded for a respective entry. Finally, as shown in FIG. 5, the “Edit Forecast” window 500 may show an “Upload” column, which a user can select to display the “Upload Documents” window 400 described above with reference to FIG. 4, so as to upload documents relevant to the financial forecasting data, as desired.

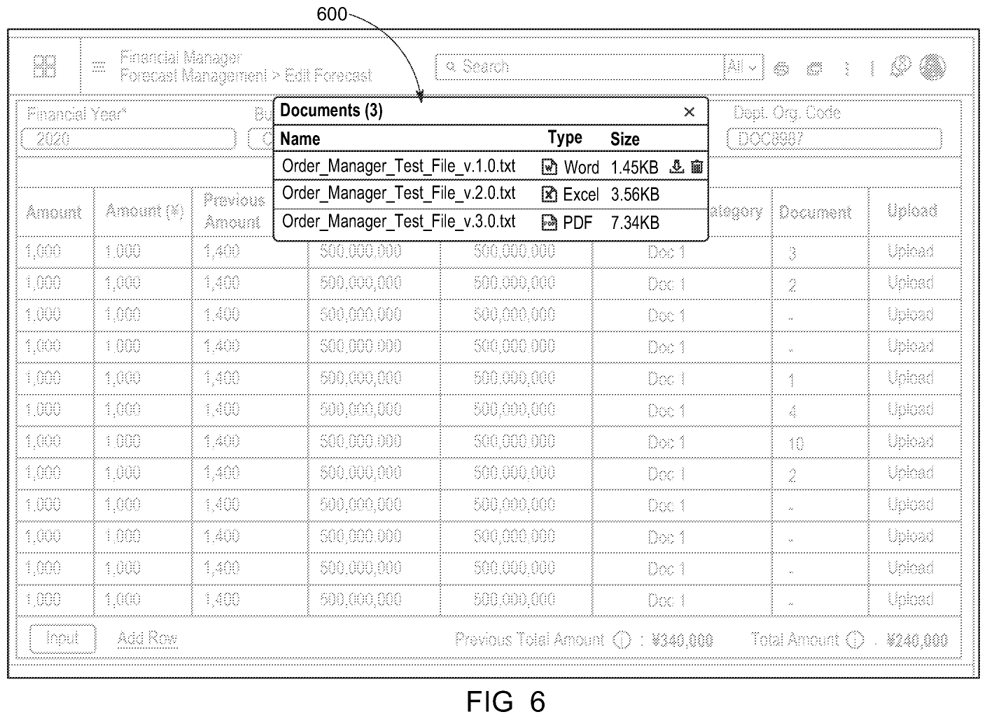

Additionally, according to one example embodiment, as shown in FIG. 6, a “Documents” window 600 of a user interface may be displayed, for instance, in response to a user clicking on the number displayed in the “Document” column. The “Documents” window 600 allows a user to review, edit, download and delete documents that have been uploaded to the financial forecasting data.

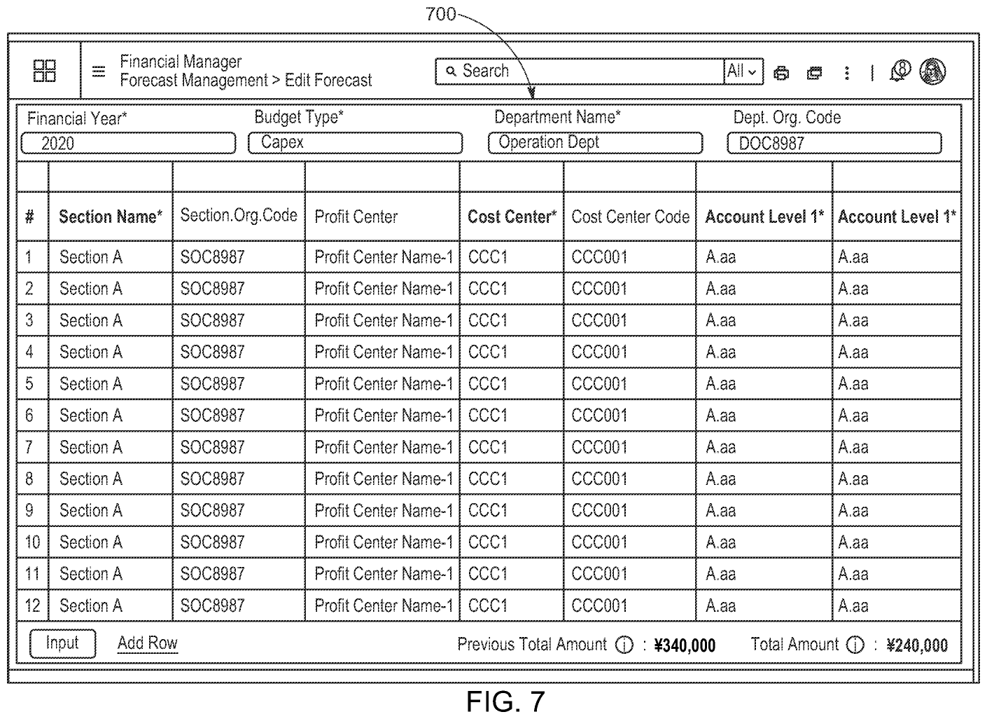

According to one example embodiment, as shown in FIG. 7, an “Edit Forecast” window 700 of a user interface may be displayed. As shown in FIG. 7, the fields in columns with titles in bold may be modified. In contrast, the fields in the columns with titles that have been displayed in grey may not be modified. A user may configure which fields may be modified and which fields cannot be modified, as desired.

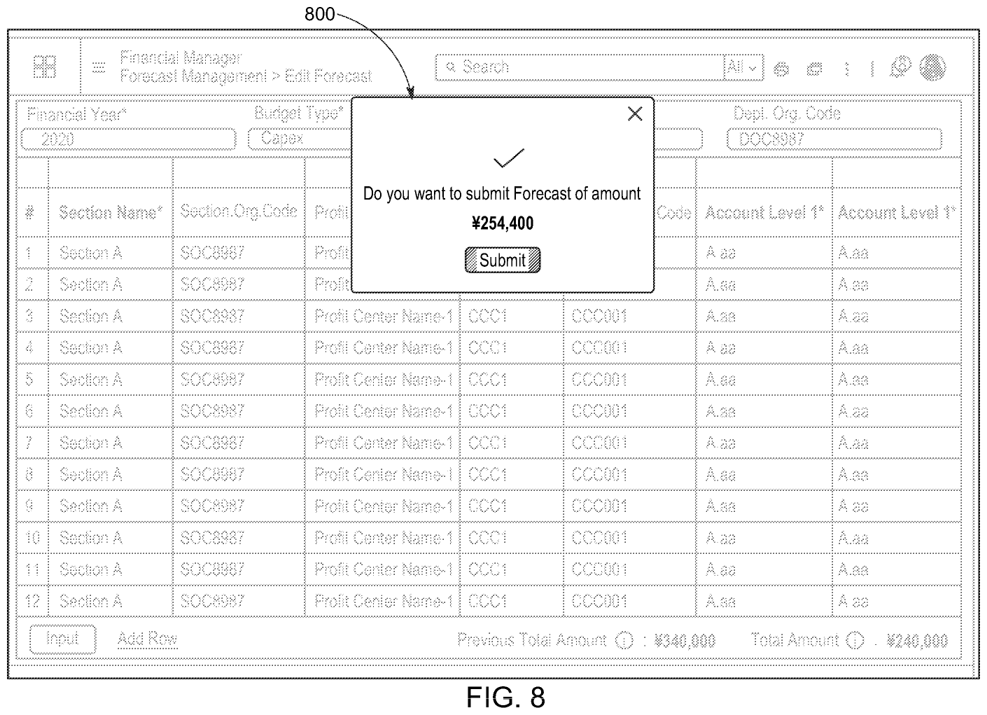

According to one example embodiment, as shown in FIG. 8, a confirmation window 800 of an “Edit Forecast” window of a user interface may be displayed. For instance, as shown in FIG. 8, the confirmation window 800 displays an inquiry asking the user whether they want to submit the particular forecast amount of ¥254,400, which has been input. The user may submit this forecast amount of ¥254,400 by clicking on the “Submit” button of the confirmation window 800.

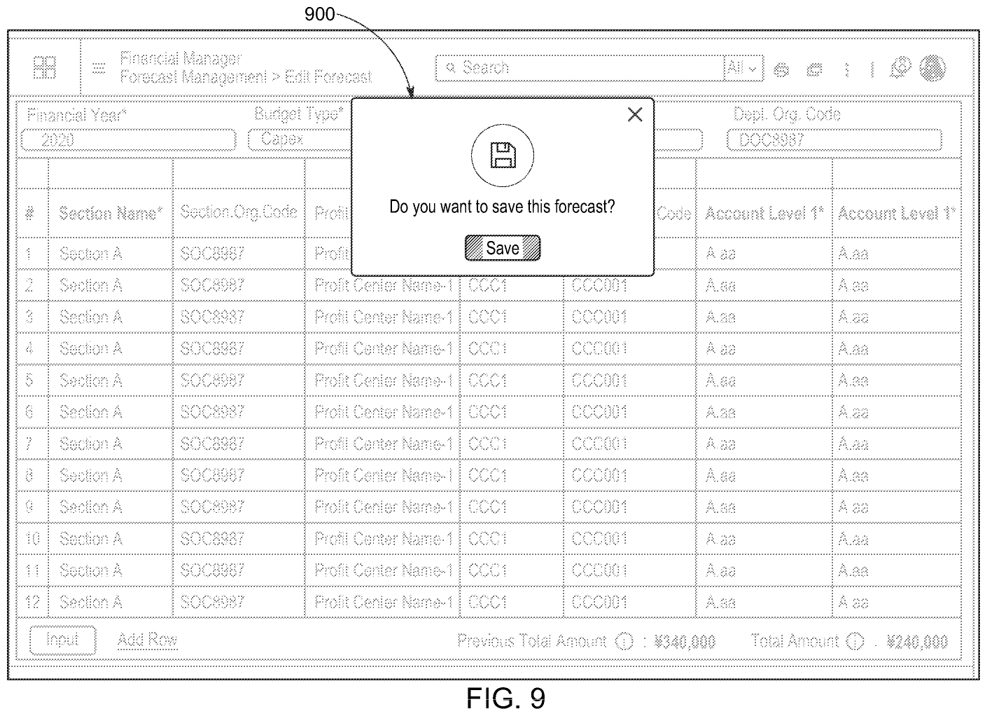

According to one example embodiment, as shown in FIG. 9, a confirmation window 900 of an “Edit Forecast” window of a user interface may be displayed. For instance, as shown in FIG. 9, the confirmation window 900 displays an inquiry asking the user whether they want to save this forecast. If desired, the user may click on the “Save” button of the confirmation window 900 to save the forecast.

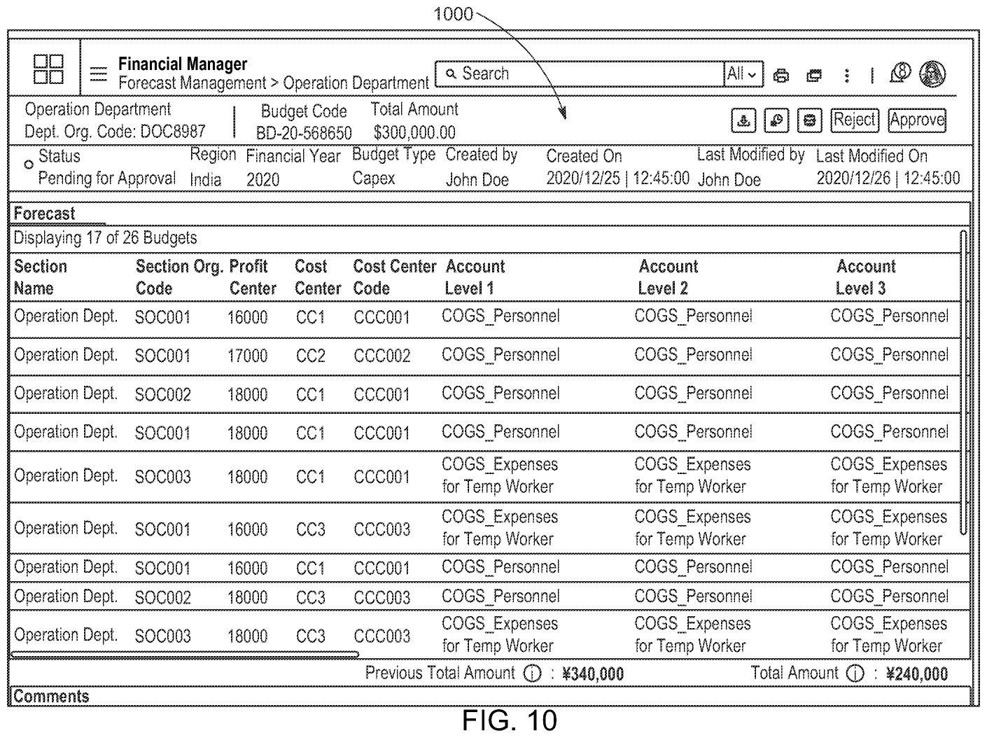

According to one example embodiment, as shown in FIG. 10, an “Operation Department” window 1000 of a user interface may be displayed. For instance, the Operation Department” window 1000 may show a detailed view of previously submitted financial forecasting data that is to be approved or rejected by an approver designated by the organization (e.g., a Department Manager, etc.). An approver may review the detailed view of financial forecasting data displayed in the “Operation Department” window 1000 and either approve or reject the submitted financial forecasting data by clicking on the “Reject” button or on the “Approve” button, as desired.

As shown in FIG. 10, the “Operation Department” window 1000 indicates the current status of the submitted financial forecasting data (i.e., “Pending for Approval”). The “Operation Department” window 1000 also identifies the particular submitted financial forecasting data by “Region”, “Financial Year”, and “Budget Type.” Moreover, the “Operation Department” window 1000 shows information such as who the submitted financial forecasting data was “Created By”, a “Created On” time, who the particular submitted financial forecasting data was “Last Modified By” and a “Last Modified On” time. However, the present application is not limited to the aforementioned configuration.

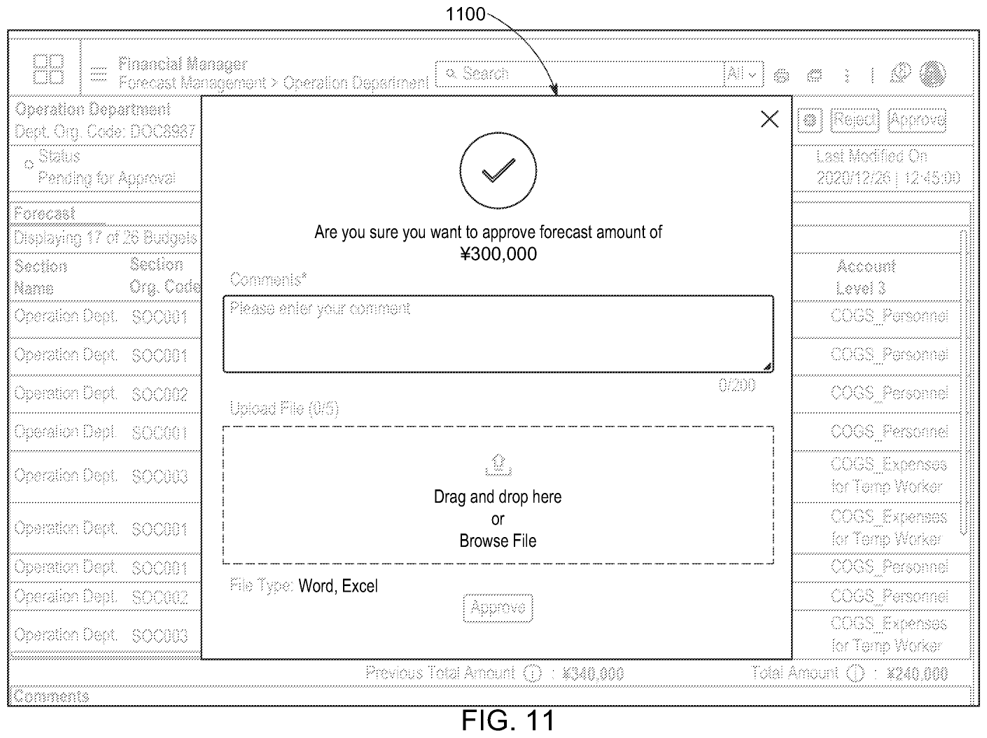

According to one example embodiment, as shown in FIG. 11, a confirmation window 1100 of an “Operation Department” window of a user interface may be displayed after an approver has selected the “Approve” button (e.g., shown in FIG. 10). As shown in FIG. 11, an inquiry is displayed in the confirmation window 1100 asking the approver whether they are sure that they want to approve the forecast amount. Additionally, the confirmation window 1100 of an “Operation Department” window is configured to allow the approver to enter any relevant comments and/or to attach any relevant files, if desired.

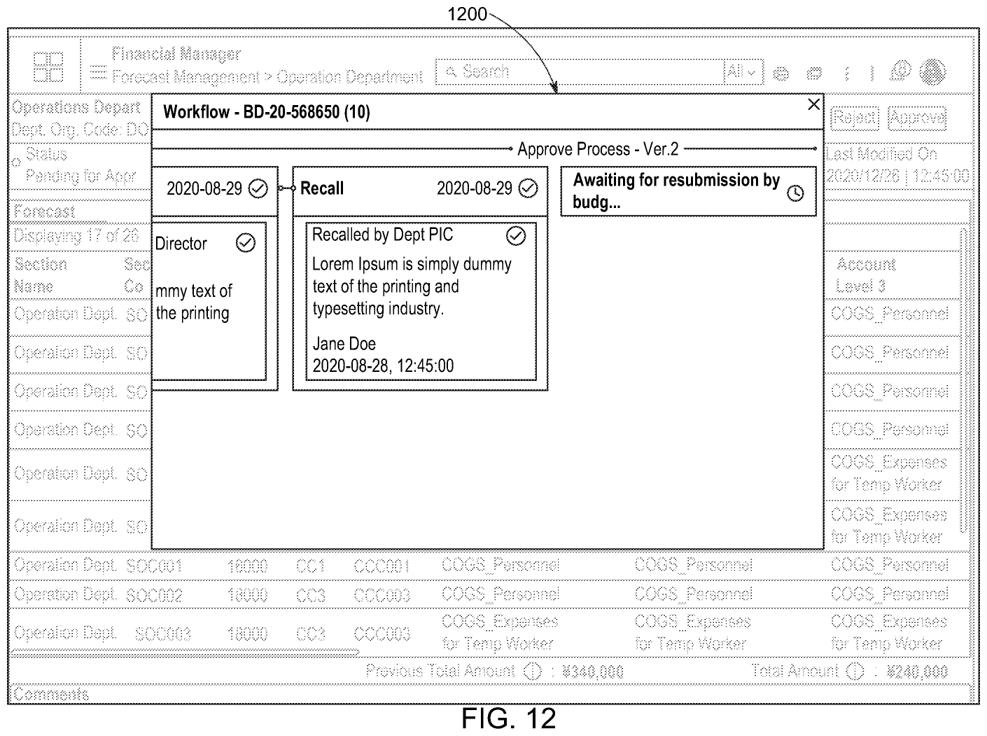

According to one example embodiment, as shown in FIG. 12, a workflow window 1200 of a user interface may be displayed. The workflow window 1200 shows the current status of financial forecasting data submitted for approval according to the approval process that has been defined. For instance, as shown in FIG. 12, the status is indicated as “Awaiting for resubmission” since the financial forecasting data submitted for approval has been recalled by the Department Person In Charge.

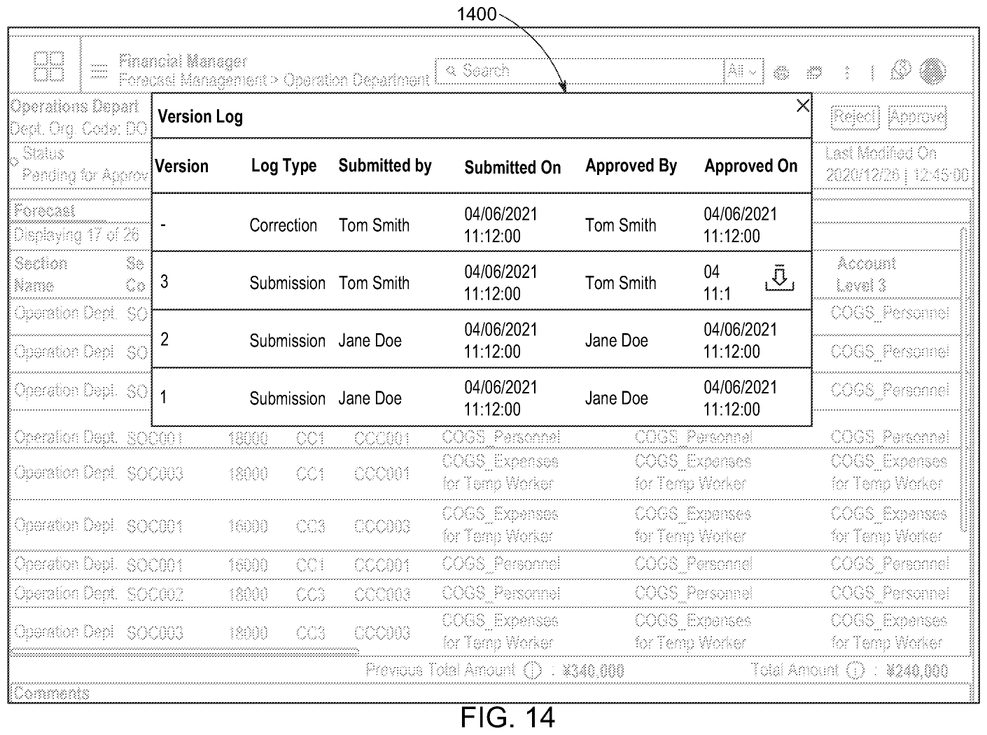

According to one example embodiment, as shown in FIG. 13, an “Operation Department” window 1300 may be displayed. As shown in FIG. 13, the “View Version Log” button of the “Operation Department” window 1300 is highlighted. A user may select the “View Version Log” button and, in response, a version log window 1400 of a user interface may be displayed, as shown in FIG. 14. The version log window 1400 allows a user to view information about the previous versions of submitted financial forecasting data, as desired.

As shown in FIG. 14, the version log window 1400 shows a “Version” column, a “Log Type” column, a “Submitted By” column, a “Submitted On” column, an “Approved By” column and an “Approved On” column. Further, as shown in FIG. 14, the entry having “Correction” listed in the “Log Type” column does not have an entry in the “Version #” column since this entry was made by a privileged user who is be allowed to correct, submit and edit financial forecasting data, such as a manager of the Accounting Department who is responsible for correcting errors in the financial forecasting data. Such entries by a privileged user may override existing financial forecasting data without prior approval.

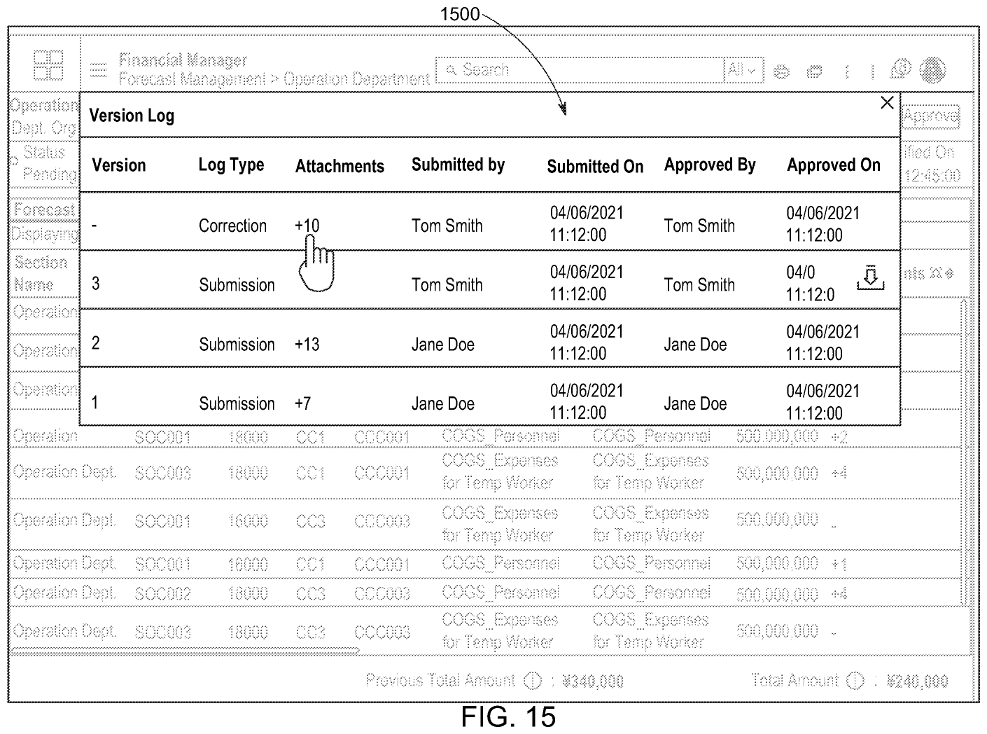

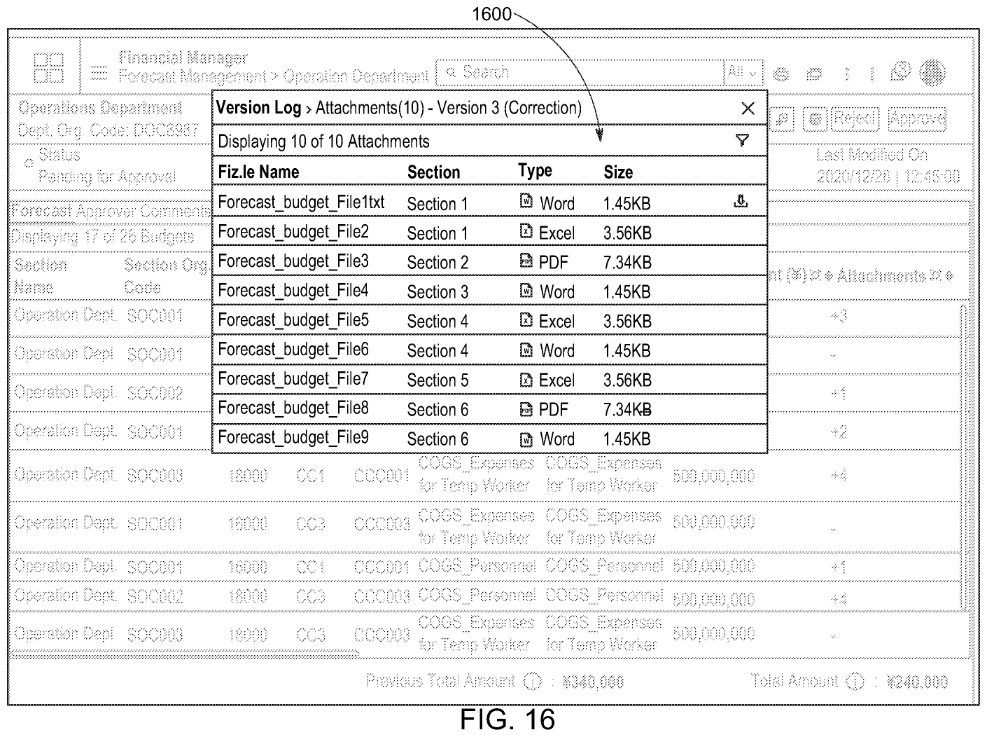

According to one example embodiment, as shown in FIG. 15, a version log window 1500 of a user interface may be displayed wherein the version log window also includes an “Attachments” column indicating a number of attached files that have been attached to a particular version log entry. For instance, as shown in FIG. 15, a user may select the highlighted “+10” in the “Attachments” column of the top entry in the version log. As a result, the user interface may display a window 1600 (as shown in FIG. 16) of a user interface which lists the 10 files attached to the top entry in the version log.

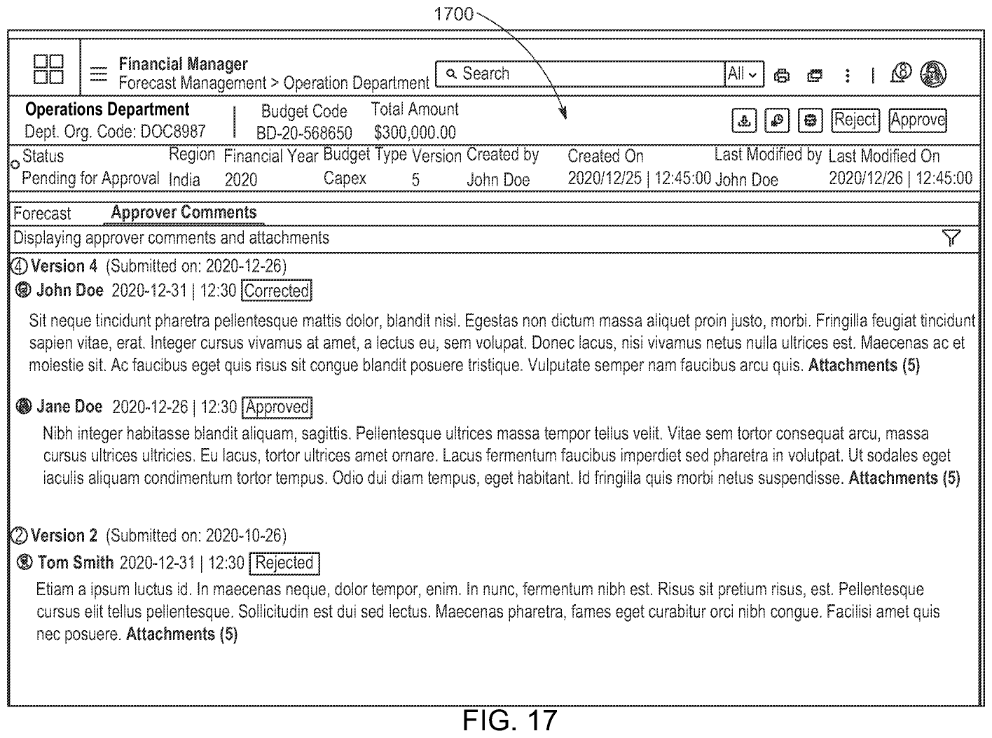

According to one example embodiment, as shown in FIG. 17, an “Operation Department” window 1700 may be displayed. As shown in FIG. 17, an approver may select an “Approver Comments” tab and display comments relevant to a particular version in the version log, if desired. For instance, the approver may review comments relevant to the approval, rejection or correction of a particular version of the submitted financial forecasting data.

According to an example embodiment of the present disclosure, a solution is provided as to how end-to-end financial forecasting is done. In order to do a financial forecasting, a department's budget must be submitted and approved for a financial year. An example embodiment provides an approval process for financial forecasting relative to the approved budget, that is implemented with configured submission periods and defined freeze times. The financial forecasting can be done on an approved budget in a periodic manner such as weekly, monthly or the like. According to an example embodiment, for each forecasting data submission, an approver must review the submission and approve it and each forecasting data submission is maintained as a different version in the version log for user to reference anytime. Also, according to an example embodiment, there is “Previous Amount” column in a forecasting table to let the user know what was the amount during last forecasting data submission and show how much is getting changed with the current forecasting.

Thus, financial forecasting may be carried out in a more systematic and efficient manner and a user has the freedom to configure an on-the-fly system, with pre-defined configured rules for data submission management and version log creation.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. An apparatus for financial forecasting, the apparatus comprising:
a memory storing instructions; and
a processor configured to execute the stored instructions to implement operations comprising:
controlling a user interface to be displayed on a display;
controlling receiving a plurality of financial forecasting data submissions that are submitted using the user interface;
controlling storing each one of the plurality of financial forecasting data submissions as a different version in a version log;
controlling receiving and storing at least one of an approval and a rejection, using the user interface, for each one of the stored plurality of financial forecasting data submissions; and
controlling the user interface to display the version log in response to a request input using the user interface.

2. The apparatus of claim 1, wherein the operations further comprise controlling receiving and storing, using the user interface, approver comments for each different version stored in the version log.

3. The apparatus of claim 1, wherein the operations further comprise controlling receiving and storing, using the user interface, a file attached to each different version stored in the version log.

4. The apparatus of claim 1, wherein the operations further comprise controlling the user interface to automatically populate a field of the financial forecasting data using a past history of financial forecasting data submissions.

5. The apparatus of claim 4, wherein the operations further comprise controlling the user interface to automatically populate the field of the financial forecasting data using a previous amount from a most recent one of the financial forecasting data submissions.

6. A method for financial forecasting, the method comprising:
controlling, by a processor, a user interface to be displayed on a display;
controlling, by the processor, receiving a plurality of financial forecasting data submissions that are submitted using the user interface;
controlling, by the processor, storing each one of the plurality of financial forecasting data submissions as a different version in a version log;
controlling, by the processor, receiving and storing at least one of an approval and a rejection, using the user interface, for each one of the stored plurality of financial forecasting data submissions; and
controlling, by the processor, the user interface to display the version log in response to a request input using the user interface.

7. The method of claim 6, wherein the method further comprises controlling, by the processor, receiving and storing, using the user interface, approver comments for each different version stored in the version log.

8. The method of claim 6, wherein the method further comprises controlling, by the processor, receiving and storing, using the user interface, a file attached to each different version stored in the version log.

9. The method of claim 6, wherein the method further comprises controlling, by the processor, the user interface to automatically populate a field of the financial forecasting data using a past history of financial forecasting data submissions.

10. The method of claim 9, wherein the method further comprises controlling, by the processor, the user interface to automatically populate the field of the financial forecasting data using a previous amount from a most recent one of the financial forecasting data submissions.

11. A non-transitory computer readable storage medium storing instructions which, if executed, cause a processor to implement operations for financial forecasting, the operations comprising:
controlling, by a processor, a user interface to be displayed on a display;
controlling, by the processor, receiving a plurality of financial forecasting data submissions that are submitted using the user interface;
controlling, by the processor, storing each one of the plurality of financial forecasting data submissions as a different version in a version log;
controlling, by the processor, receiving and storing at least one of an approval and a rejection, using the user interface, for each one of the stored plurality of financial forecasting data submissions; and
controlling, by the processor, the user interface to display the version log in response to a request input using the user interface.

12. The non-transitory computer readable storage medium of claim 11, wherein the operations further comprise controlling, by the processor, receiving and storing, using the user interface, approver comments for each different version stored in the version log.

13. The non-transitory computer readable storage medium of claim 11, wherein the operations further comprise controlling, by the processor, receiving and storing, using the user interface, a file attached to each different version stored in the version log.

14. The non-transitory computer readable storage medium of claim 11, wherein the operations further comprise controlling, by the processor, the user interface to automatically populate a field of the financial forecasting data using a past history of financial forecasting data submissions.

15. The non-transitory computer readable storage medium of claim 14, wherein the operations further comprise controlling, by the processor, the user interface to automatically populate the field of the financial forecasting data using a previous amount from a most recent one of the financial forecasting data submissions.
